(19) United States
(12) Patent Application Publication
(10) Pub. No.: US 2015/0331889 A1
(43) Pub. Date: Nov. 19, 2015

(54) Method of Image Tagging for Identifying Regions and Behavior Relationship between Different Objects

(71) Applicant: National Tsing Hua University, Hsin Chu City (TW)

(72) Inventors: Hao-Chuan WANG, Hsin Chu City (TW); Hsing-Lin TSAI, Hsin Chu City (TW)

(21) Appl. No.: 14/555,673

(22) Filed: Nov. 27, 2014

(30) Foreign Application Priority Data
May 15, 2014 (TW) 103117194

(51) Int. Cl. G06F 17/30; G06F 3/0482; G06F 3/0484

(52) U.S. Cl. CPC G06F 17/30268; G06F 17/30601; G06F 3/04842; G06F 3/0482; G06F 17/30371

(57) ABSTRACT

A method of image tagging for identifying regions and behavior relationship between different objects, the method comprising: providing a photo database downloaded a photo to a graphical user interface of an electronic device; providing a graphic module which comprises a graphic interface that overlapped on said photo, said graphic module further comprises one or more tagging tools to generate one or more Icons on said graphic interface; said tagging tools comprise at least a selecting tool to allow a user select a first object and a second object of said photo, and a linking tool to allow said user combine said first object with said second object; wherein, appearing a text input to input a message related to said first object and said second object when using said tagging tool; and appearing a validation window on said graphic user interface to verify said label of said photo tagged by said user after tagging completely.

### CROSS-REFERENCE TO RELATED APPLICATION

The present application claims the benefit of TAIWAN Patent Application Serial Number 103117194, filed on May 15, 2014, which are herein incorporated.

### TECHNICAL FIELD

The present invention generally relates to a method for tagging, more particularly, to a method of image tagging for identifying regions and behavior relationship between different objects.

### BACKGROUND OF RELATED ART

“Image tagging” is essential for digital images that is used to act as an index tools for searching photos or images. In general conditions, it's hard to search a photo or an image precisely without any related description or tags of the photo or image uploaded to a website by a user.

“Human computation” is combined with contribution from human, different from execution of CPU, so that may solve many problems that computers could not do, such as image analysis and voice recognition. The advantage of human computation is that volunteers could provide any information based on their observation and advice.

ESP game, proposed from Luis von Ahn, is an idea in computer science for addressing the problem of creating difficult metadata. The idea behind the games is to use the computational power of humans to perform a task that computers cannot do (originally, image recognition) by packaging the task as a game. A user is automatically matched with a random partner. The partners do not know each other's identity and they cannot communicate. Once matched, they will both be shown the same image. Their task is to agree on a word that would be an appropriate label for the image. They both enter possible words, and once a word is entered by both partners (not necessarily at the same time), that word is agreed upon, and that word becomes a label for the image.

In the art, image tagging system, based on the human computation, only provided information about entity, but could not provide precision region of different objects in a photo or image. It is impossible to provide relationship between different objects, neither. Besides, the conventional general image tagging could not provide entire information to improve searching system.

In order to solve the problem of the prior art, the present invention provides a method of image tagging for identifying regions and behavior relationship between different objects.

### SUMMARY

An object of the present invention is to provide a method of tagging for identifying regions of objects.

Another object of the present invention is to provide a method of tagging for identifying behavior relationship between different objects.

Another additional object of the present invention is to provide a method for rewarding users who providing information of images.

According to an aspect of the invention, it proposes a method of image tagging for identifying regions and behavior relationship between different objects, the method comprising: providing a photo database downloaded a photo to a graphical user interface of an electronic device; providing a graphic module which comprises a graphic interface that overlapped on said photo, said graphic module further comprises one or more tagging tools to generate one or more Icons on said graphic interface; said tagging tools comprise at least a selecting tool to allow a user select a first object and a second object of said photo, and a linking tool to allow said user combine said first object with said second object; wherein, appearing a text input to input a message related to said first object and said second object when using said tagging tool; and appearing a validation window on said graphic user interface to verify said label of said photo tagged by said user after tagging completely.

According to another aspect of the invention, it proposes an analysis for image tagging. The graphic module of the present invention may further include a storage unit for saving tagged images. The graphic module of the present invention may further include a processing unit to analyze the photo stored in the storage unit. Finally, users would gain a score according to analysis from processing unit.

### BRIEF DESCRIPTION OF THE DRAWINGS

The components, characteristics and advantages of the present invention may be understood by the detailed description of the preferred embodiments outlined in the specification and the drawings attached.

FIG. 1 illustrates a flow chart of a method for image tagging according the embodiment of the present invention.

FIG. 2 illustrates a block diagram of a system for image tagging according the embodiment of the present invention.

FIG. 3A illustrates a diagram for image tagging according the embodiment of the present invention.

FIG. 3B illustrates a diagram of a validation window according the embodiment of the present invention.

FIG. 4 illustrates a diagram of classification of labels according the embodiment of the present invention.

FIG. 5A illustrates a diagram of classification of behavior labels according the embodiment of the present invention.

FIG. 5B illustrates a diagram of classification of segment tools according the embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

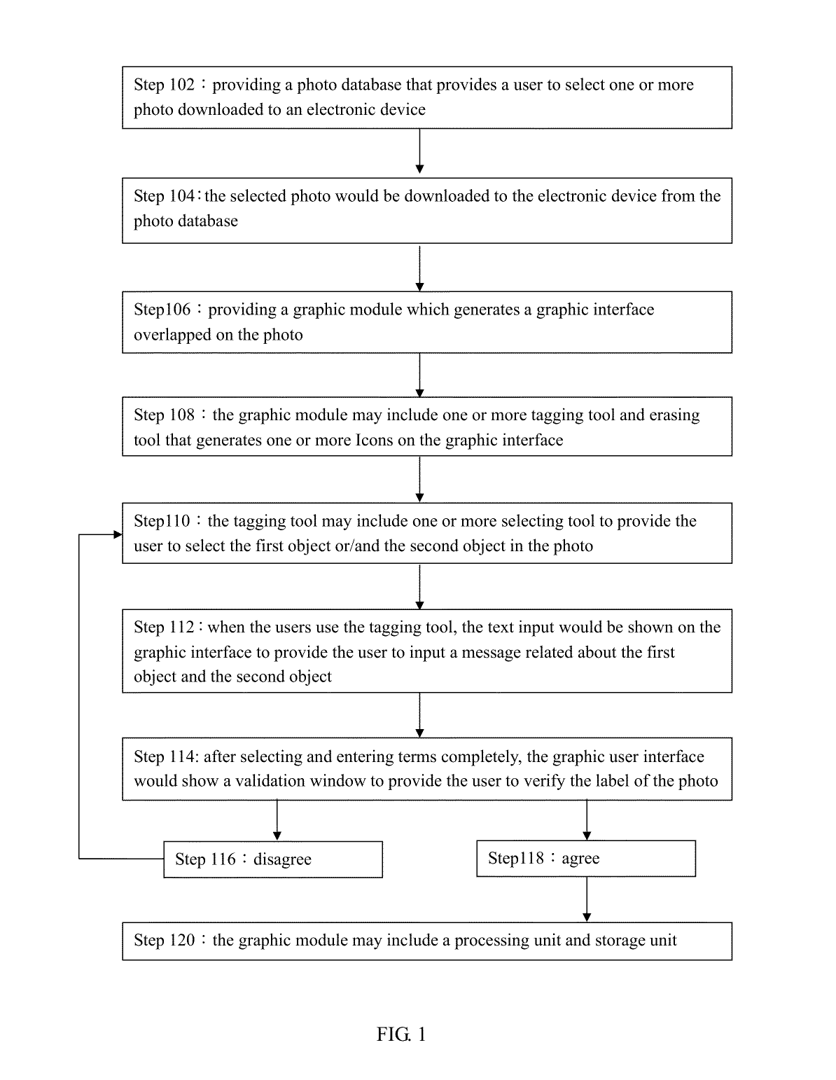

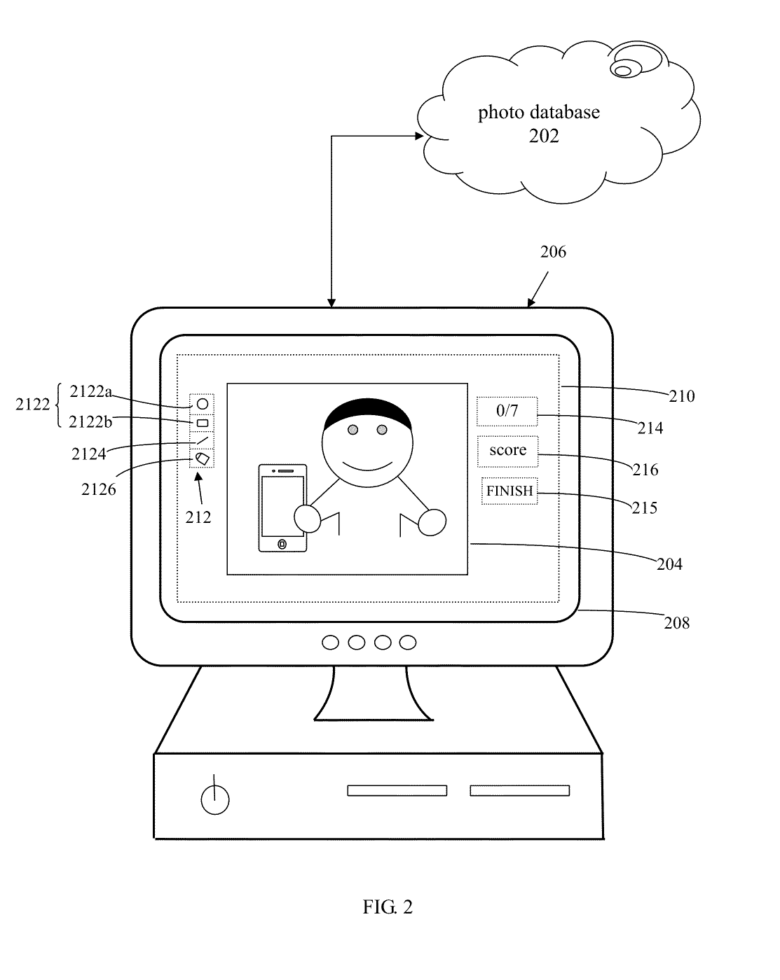

FIGS. 1 and 2 show a flow chart and block diagram for image tagging according to the embodiment of the present invention. The method for image tagging comprises:

Step 102: Providing a photo database 202 that provides a user (not shown) to select one or more photo 204 downloaded to an electronic device 206. The user may select one or more photo 204 to download to the electronic device 206 from the photo database 202 by any network (including cable or wireless). The protocol includes WCDMA, WiFi or Bluetooth. In one embodiment, the photo 204 would be assigned by the user or the system of the present invention. In another embodiment, the photo 204 would be less of tags and selected preferentially. The photo database 202 may include but be not limited to Google photo database, Yahoo photo database or other network or program which is available to provide photos. The electronic device may include but be not limited to desktop computer, notebook, tablet, smartphone, other electronic device which is available to link network.

Step 104: The selected photo 204 would be downloaded to the electronic device 206 from the photo database 202 by any network. The protocol includes WCDMA, WiFi or Bluetooth and selected photo 204 is shown on the graphic user interface (GUI) 208 of the electronic device 206. The electronic device 206 should have programs which support the user to open and view the photo 204 on the graphic user interface 208, such as JPEG, JPG, GIF, PNG, BMP or other related program.

Step 106: Providing a graphic module (not shown) which generates a graphic interface 210 overlapped on the photo 204. The graphic module 202 may generate the graphic interface 210 on the electronic device 206 in the present invention. In one embodiment, the graphic interface 210 may be a transparent layer that could be overlapped on the photo 204, so that the user would easily view the photo 204 even it is covered by the graphic interface 210. In one embodiment, the user could tag the photo 204 on the graphic interface 210.

Step 108: The graphic module may include one or more tagging tool 212 and erasing tool 2126 that generates a plurality of Icons on the graphic interface 210, so as to tag the photo 204 by the user. As shown in FIG. 2, the graphic module provides a simple tagging tool 212 and erasing tool 2126 that generates related Icons on the graphic interface 210.

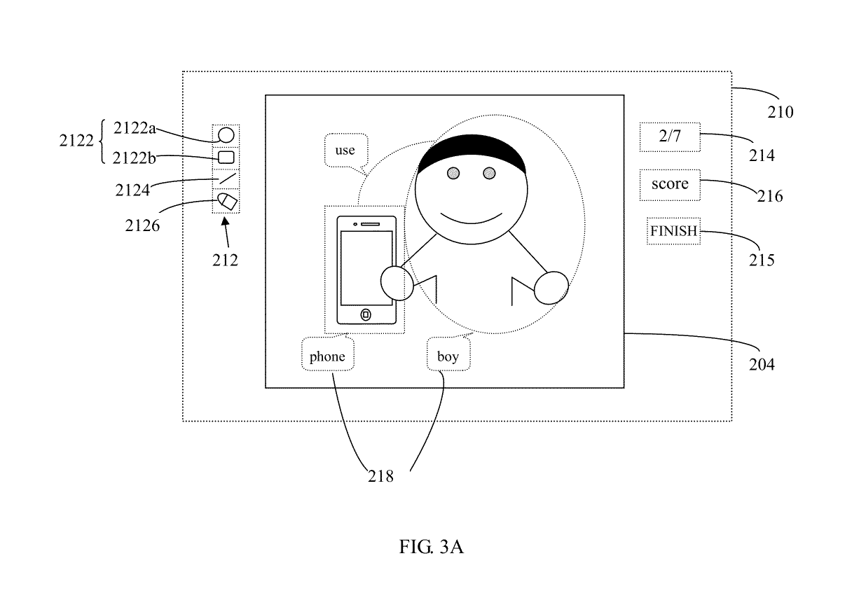

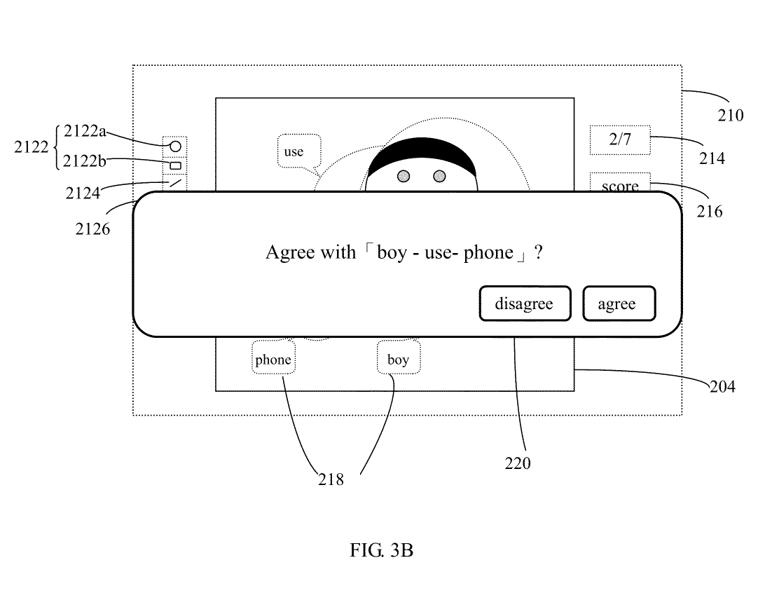

Step 110: The tagging tool 212 may include one or more selecting tool 2122 to provide the user to select the first object or/and the second object in the photo 204. The tagging tool 212 may include one or more selecting tool 2122, such as circle selecting tool 2122a, rectangle selecting tool 2122b or other angular selecting tool (not shown), so as to the user assign a particular region of the photo 204. The user may select required and proper selecting tool 2122 based on the size and shape of objects of the photo 204. As shown rectangle dotted line in FIG. 3A, the user could use the rectangle selecting tool 2122b to select an iPhone object in the photo 204. And shown circle dotted line in FIG. 3A, the user could use the circle selecting tool 2122a to select a boy in the photo 204. Furthermore, the selecting tool 212 may rotate an angle to match selected objects (not shown).

The tagging tool 212 further may include a linking tool 2124 to allow the user combine the first object and the second object. After selecting a particular region in the photo 204 by the selecting tool 2122, the user may further combine different objects by linking tool 2124 to indicate a particular relationship between different objects. The linking tool 2124 may include but not limited to line, curve or other segments. The length of the segment depends on the distance between the first object and the second object.

The tagging tool 212 further may include a erasing tool 2126 to allow the user delete error tagging if the regions selected and/or the linked segments are incorrect.

Step 112: When the users use the tagging tool, the text input 218 would be shown on the graphic interface 210 to let the user input a message related with the first object and the second object. For example, the user select the first object by the selecting tool 2122, then the text input 218 would be shown on the graphic interface 210 to input a message for the first object by the user, such as title, feature, property, and so on. As shown in FIG. 3A, the step is to enter “phone” or “cell phone” into the text input 218 after selecting a phone object. In one embodiment, it could repeat to tag the same object with different messages, such as “cell phone”, “mobile phone”, “smartphone”, “phone”, and so on. And entering “boy” into the text input 218 after selecting a boy object.

In prior art, it only tagged object with its property or feature, no any relationship between different objects can be generated. In order to improve the integrity of the image tagging, the present invention provides a method for tagging with behavior relationship between different objects. For example, if the first object is tagged as boy and the second object is tagged as cell phone. Then, the user could combine the first object and the second object by linking tool 2124 and enter “use” or other related term into text input 218, as shown in FIG. 3A.

The graphic module may further include the instruction window 214 to provide the required instruction to the user on the graphic interface 210, such as “2/7” represents two labels have been done in all of seven labels. When the user finished all instruction, the instruction window 214 would show “X/X.”

Step 114: After selecting and entering terms completely, the graphic user interface 208 would show a validation window for the user to verify the label of the photo. As shown in FIG. 3, according above mentioned embodiment, the user may click “FINISH” button 215 after tagging completely. Then, the validation window 220, appeared on the graphic interface 210, is provided to user to agree with whether “boy-use-phone” or not. The validation window 220 further may include “agree” and “disagree” buttons, as shown in FIG. 3B

Step 116: If the user clicked the “disagree” button, it would be return back to the graphic interface 210 to restart to tag, repeat step 110˜114 until the user agree the label of tagging.

Step 118: The label of tagging would be stored in the storage unit (not shown) of the graphic module after the user click the “agree” button.

Step 120: The graphic module may include a processing unit and a storage unit. The processing unit and storage unit are combined each other. Tagging photo 204 stored in the storage unit would be analyzed by the processing unit with comparing the other tagging photo 204 tagged by the other user. Then, the processing unit may further calculate the score 216 based on the analysis. For example, if user A complete ten tags, the processing unit would be analyze the photo tagged by user A with comparing the other photo tagged by the user B. It should be understand that the user B completed tagging earlier than the user A, thus, the photo tagged by the user B could be act as a reference. If the user B completed eight tags, the user A would gain score X. If the user B completed twelve tags, the user would gain score Y. X is greater than Y or equal to Y. It should be understand that the user would gain more score if complete more tags. The method of calculating score may include but be not limited to above mentioned methods. In order to reward the contributions from the user, it adopts not only score but also bonus, wherein bonus may be utilized to but be not limited to change virtual merchandise, virtual money or cash.

In order to verify the present invention could improve the integrity of image tagging, we recruit 72 users to utilize the present invention, wherein the 72 user include 49 males and 23 females. They completed 3784 tags in all of 119 photos, the average photo would get 31 tags and be tagged by 6.5 recruits. The amount of tags of the selecting tool may be 1700, and linking tool may be 260.

We classified 3784 tags to realize the distribution of tags by coding scheme from Dong & Fu. We classified all tags based on feature, such as Entity, Property, Behavior, Relationship, Overall Description and Uncodable. In one embodiment, we have three recruits to classify all tags. Each image must be classified by more recruits, and the unity of different recruits is high between 89.8%-96.2%. But if there have different classification in the same tag, it would discuss the final classification by more recruits. Most of tags both have two type of classification, such as “Behavior+Entity”, “Property+Entity”, “Property+Behavior”, and so on. Composite tags may include two or two more different classification.

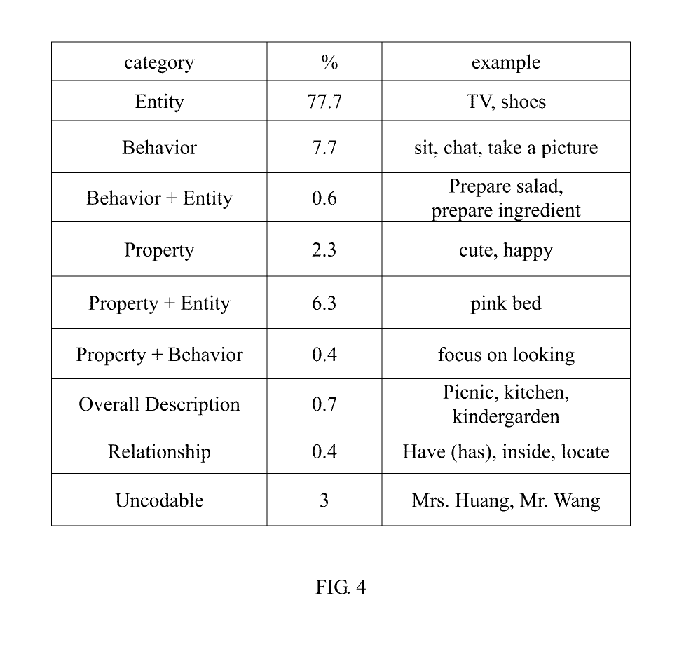

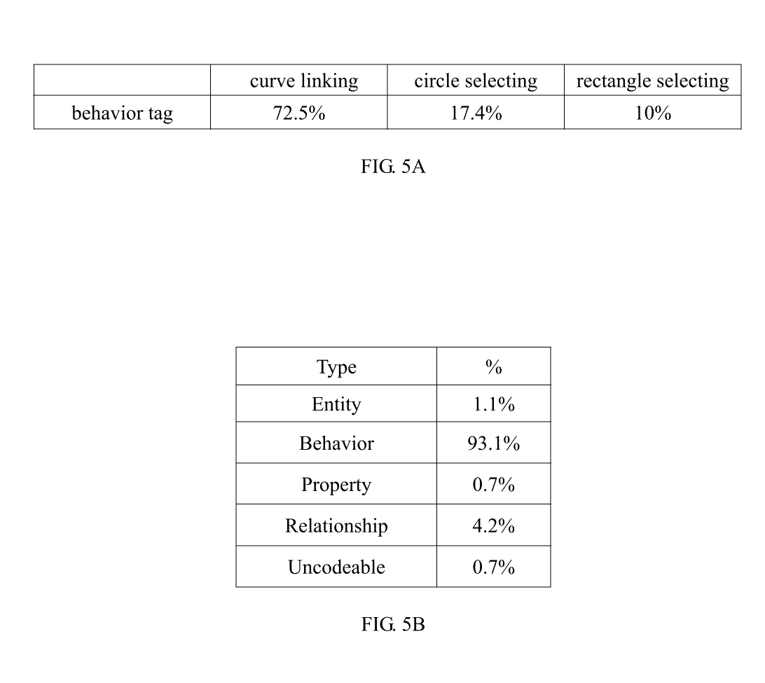

FIG. 4 shows classification of all tags. It clearly figures out that users usually provide tags with single classification, wherein the tags with Entity (such as title of objects) are 77.7% of all tags. The tags with Behavior are 7.7% of all tags which could not be achieved by prior art. It will be seen from that the present invention could improve the utility of image tagging. Furthermore, comparing Property (2.3%) and Property+Entity (6.3%), it figures out overall description are more than single description. Namely, the users described objects with not only title, but also color or feature. Ten percent of the tags with Property may include description about property of objects or things, such as subjective description (ex: happy or attention). The effect of the present invention could not be achieved easily by prior art. As shown classification in FIG. 5A, 72.5 percent of the tags with Behavior are composed of linking tool. On the other side, 93 percent of tags composed of linking tool are Behavior, as shown in FIG. 5B.

It should be understood that validation of method, the number of people, the number of tags, classification, etc may include but be not limited to as mentioned above. The effect of the present invention could be achieved by other validation.

To conclude, the present invention providing selecting tools and linking tools would improve recognition of regions and behavior relationship between objects which could not be achieved by prior art. Further, it would be promote the accuracy of image tagging and searching photos by the present invention.

Various embodiments of the present invention may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), EEPROM, magnet or optical cards, flash memory, or other type of media/machine-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modification and adaptions can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A method for image tagging for identifying regions and behavior relationship between different objects, the method comprising:
providing a photo database downloaded a photo to a graphical user interface of an electronic device;
providing a graphic module which comprises a graphic interface that overlapped on said photo, said graphic module further comprises one or more tagging tools to generate one or more Icons on said graphic interface;
said tagging tools comprise at least a selecting tool to allow a user select a first object and a second object of said photo, and a linking tool to allow said user combine said first object with said second object;
wherein, appearing a text input to input a message related to said first object and said second object when using said tagging tool; and
appearing a validation window on said graphic user interface to verify said label of said photo tagged by said user after tagging completely.

2. The method of claim 1, wherein said photo database comprises Google photo database or Yahoo photo database.

3. The method of claim 1, wherein said graphic interface is a transparent interface.

4. The method of claim 1, wherein said selecting tool comprises enclosed shape which comprising circle or rectangle, the size of selected region depends on location and scope of said first object and said second object.

5. The method of claim 1, wherein said linking tool comprises segments which comprising line or curve, the length of linked segment depends on the distance between said first object and said second object.

6. The method of claim 1, wherein said tagging tool comprises an erasing tool to provide said user to delete error tags.

7. The method of claim 1, wherein said graphic module further comprises at least an instruction window to show required instructions that would be done by the user.

8. The method of claim 1, wherein said graphic module further comprises a storage unit to store said label of said photo.

9. The method of claim 1, wherein said graphic module further comprises a processing unit to analyze said label of said photo.

10. The method of claim 9, wherein said processing unit calculates a required score to said user based on said analysis of said label of said photo.

11. The method of claim 1, wherein said method for selection of said photo comprises random selection.

12. A method for image tagging for identifying regions and behavior relationship between different objects, the method comprising:
providing a photo database downloaded a photo to a graphical user interface of an electronic device;
providing a graphic module which comprises a graphic interface that overlapped on said photo, said graphic module further comprises one or more tagging tools to generate one or more Icons on said graphic interface;
said tagging tools comprise at least a selecting tool to allow a user select a first object and a second object of said photo, and a linking tool to allow said user combine said first object with said second object;
wherein, appearing a text input to input a message related to said first object and said second object when using said tagging tool;
appearing a validation window on said graphic user interface to verify said label of said photo tagged by said user after tagging completely;
analyzing said label of said photo by a processing unit of said graphic module; and
calculating a score based on the analysis of said label of said photo by said processing unit.

13. The method of claim 12, wherein said photo database comprises Google photo database or Yahoo photo database.

14. The method of claim 12, wherein said graphic interface is a transparent interface.

15. The method of claim 12, wherein said selecting tool comprises enclosed shape which comprising circle or rectangle, the size of selected region depends on location and scope of said first object and said second object.

16. The method of claim 12, wherein said linking tool comprises segments which comprising line or curve, the length of linked segment depends on the distance between said first object and said second object.

17. The method of claim 12, wherein said tagging tool comprises an erasing tool to provide said user to delete error tags.

18. The method of claim 12, wherein said graphic module further comprises at least an instruction window to show required instructions that would be done by the user.

19. The method of claim 12, wherein said graphic module further comprises a storage unit to store said label of said photo.
